(19) United States
(12) Patent Application Publication
(10) Pub. No.: US 2014/0274694 A1
(43) Pub. Date: Sep. 18, 2014

(54) Molasses as a Soil Amendment

(71) Applicant: Auburn University, Auburn, AL (US)

(72) Inventors: Robert Rodriguez-Kabana, Auburn, AL (US); Lee J. Simmons, Tallassee, AL (US); C. Robert Taylor, Opelika, AL (US)

(73) Assignee: AUBURN UNIVERSITY, Auburn, AL (US)

(21) Appl. No.: 14/212,564

(22) Filed: Mar. 14, 2014

Related U.S. Application Data
(60) Provisional application No. 61/783,304, filed on Mar. 14, 2013.

(51) Int. Cl. C05G 3/02

(52) U.S. Cl. CPC C05G 3/02
USPC 504/101; 504/291

(57) ABSTRACT

Disclosed are compositions that include molasses. The disclosed compositions may be utilized as soil amendments for controlling pests, and/or weeds and/or for enhancing growth of plants.

### CROSS-REFERENCE TO RELATED APPLICATIONS

The present application claims the benefit of priority under 35 U.S.C. §119(e) to U.S. Provisional Application No. 61/783,304, filed on Mar. 14, 2013, the content of which is incorporated by reference herein in its entirety.

### BACKGROUND

The field of the invention relates to compositions comprising molasses. In particular, the field of the invention related to the use of compositions comprising molasses as soil amendments.

The benefits of amending soil with molasses are recognized in the field of agriculture. In particular, molasses is recognized as a fertilizer and also as a nematicide. (See, e.g., Rodriguez-Kabana et al., Nematropica Vol. 10, No. 1, 1980). However, previous formulations of molasses used as soil amendments are not stable. In addition, molasses also may exhibit phytotoxic effects when used as a soil amendment for example where molasses may have a phytotoxic pH or the amount of carbon contributed by molasses to amended soil alters the C:N ratio in the soil outside a non-phytotoxic range. In order to ameliorate the phytotoxicity that results from adding excess carbon to soil, a nitrogen source may be added to a soil amendment composition such that the composition has a suitable C:N ratio. However, adding excess nitrogen to soil has been observed to encourage growth of weeds. Therefore, new compositions that include molasses and additional components that modulate the phytotoxicity of molasses for use as soil amendments are desirable.

### SUMMARY

Disclosed are compositions that comprise molasses. The disclosed compositions may be useful as soil amendments for controlling pests, controlling weeds, or enhancing growth of crops as a fertilizer. The disclosed compositions may be utilized as soil amendments either alone or in combination with additional ingredients.

In some embodiments, the disclosed compositions are utilized as soil amendment compositions for plants for controlling soil-borne pests, weeds, or both, and/or for enhancing growth of the plants. The compositions typically comprise an effective amount of molasses for controlling soil-borne pests, weeds, or both, and/or for enhancing growth of the plants.

The disclosed compositions typically include: (a) molasses; (b) one or more acids; and (c) a nitrogen source; wherein the composition has a molar ratio of total carbon to total nitrogen (C:N) of about (22.4-5.6):1. Typically, the composition has a pH of about 4.0-7.0.

In some embodiments, the composition comprises a phosphorus source. Suitable phosphorus sources may include, but are not limited to, phosphoric acid (H₃PO₄), phosphorous acid (H₃PO₃), and phosphate salts (e.g., sodium phosphate salts such as NaH₂PO, Na₂HPO₄, Na₃PO₄, and/or potassium phosphate salts such as KH₂PO₄, K₂HPO₄, and K₃PO₄).

In some embodiments, the composition comprises a potassium source. Suitable potassium sources may include, but are not limited to, potassium hydroxide (KOH) or potassium salts (e.g., potassium phosphate salts).

The composition typically includes one or more acids, which may include organic acids, inorganic acids, or mixtures of organic acids and inorganic acids). Optionally, the composition includes at least one weak acid, for example, where the weak acid has a pKₐ of greater than about 0.1, 2, 3, 4, or S (or a pKₐ within a range of about 4-5). Suitable organic acids may include, but are not limited to carboxylic acids (e.g., acetic acid, propionic acid, butyric acid, valeric acid and mixtures thereof), polycarboxyclic acids (e.g., oxalic acid, malonic acid, succinic acid, glutaric acid, and mixtures thereof), and polyhydroxycarboxylic acids (e.g. citric acid). Suitable inorganic acids may include phosphorus-containing acids (e.g., phosphoric acid), sulfur-containing acids (e.g., sulfuric acid), and mixtures of phosphorus-containing acids and sulfur-containing acids. In some embodiments, the compositions comprise an organic acid (e.g., a carboxylic acid) and phosphoric acid.

The composition typically includes one or more nitrogen sources. Suitable nitrogen sources may include, but are not limited to urea.

In some preferred embodiments, the composition may include: (a) molasses (e.g., at a concentration of about 40-60% (w/w)); (b) carboxylic acid (e.g., at a concentration of about 5-15% (w/w)); (c) a phosphorus source (e.g., at a concentration of about 1-3% (w/w)); (d) a potassium source (e.g., at a concentration of about 1-5% (w/w)); (e) a nitrogen source (e.g., at a concentration of about 10-20% (w/w)).

The disclosed compositions may have a pH of about 4.0-7.0. In some embodiments, the pH of the compositions may be adjusted by adding an acid to the composition. Suitable acids include, but are not limited to, organic acids such as carboxylic acids (e.g., acetic acid, propionic acid, butyric acid, valeric acid, or mixtures thereof), polycarboxylic acids (e.g., oxalic acid, malonic acid, succinic acid, glutaric acid, and mixtures thereof), polyhydrocarboxylic acids (e.g., citric acid), inorganic acids (e.g., phosphoric acid, sulfuric acid, or mixtures thereof), or mixtures of organic acids and inorganic acids. In some embodiments, the acid is a mixture an organic acid and an inorganic acid, such as a mixture of a C2-C5 carboxylic acid and phosphoric acid (preferably at a ratio of about (3-1):1 or at a ratio of about 2:1). In other embodiments, the pH of the composition is adjusted by adding a base to the composition. Suitable bases may include, but are not limited to hydroxides (e.g., KOH).

The disclosed compositions typically include molasses and further may include additional components that are suitable as soil amendments. For example the disclosed compositions may include additional components such as pesticides (e.g., nematocides, insecticides, fungicides, and herbicides), fertilizers, or combinations thereof. The disclosed compositions further may include glycerin, which may include glycerin obtained as a by-product of biodiesel production (e.g., see U.S. Pat. No. 8,519,009, the content of which is incorporated herein by reference in its entirety). For example, the disclosed compositions may include biodiesel glycerin that optionally is treated by adding an acid to the biodiesel glycerin and optionally removing any precipitate from the treated biodiesel glycerin. The disclosed compositions further may comprise a source of sulfur. Suitable sources of sulfur may include sulfur-containing acids or sulfur-containing salts (e.g., thiosulfate salts). Additional agents may include, but are not limited to guanidine compounds such as guanidine hydrochloride, and cyanamide compounds such as hydrogen cyanamide.

The disclosed compositions may be utilized as soil amendment compositions for plants for controlling soil-borne pests, weeds, or both (e.g., as a pesticide), and/or for enhancing growth of plants (e.g., as a fertilizer). In some embodiments, the soil-borne pests are parasitic nematodes such as Rotylenchulus reniformis. The disclosed compositions may be effective for reducing parasitic nematodes populations in amended soil by at least about 50% (preferably by at least 60%, 70%, 80%, or 90%), for example where the disclosed compositions comprise about 10% molasses (w/w) and are applied at an application rate of at least about (or no more than about) 5 ml/kg soil. 10 ml/kg soil, 20 ml/kg soil, 30 mL/kg soil, 40 ml/kg soil, or 50 ml/kg soil), effectively to apply 0.5 g/kg soil, 1 g/kg soil, 2 g/kg soil, 3 g/kg soil, 4 g/kg soil, or 5 g/kg soil.

In further embodiments, the disclosed compositions may not have a significantly detrimental effect on beneficial nematodes. For example, in some embodiments the disclosed compositions do not reduce beneficial microbivorous or saprophagous nematodes in amended soil by more than about 50% (preferably by no more than 40%, 30%, 20%, or 10%), for example where the disclosed compositions comprise about 10% molasses (w/w) and are applied at an application rate of at least about (or no more than about) 5 ml/kg soil, 10 ml/kg soil, 20 ml/kg soil, 30 ml/kg soil, 40 ml/kg soil, or 50 ml/kg soil), effectively to apply 0.5 g/kg soil, 1 g/kg soil, 2 g/kg soil, 3 g/kg soil, 4 g/kg soil, or 5 g/kg soil. Preferably, the disclosed compositions enhance beneficial microbivorous or saprophagous nematodes in amended soil by more than about 10% (preferably by more than at least 20%, 30%, 40%, or 50%), when applied as contemplated.

The disclosed compositions may be utilized as soil amendments. In some embodiments, the composition includes molasses and further includes a nitrogen source. In some embodiments, the disclosed compositions include molasses and a nitrogen source and have a molar ratio of total carbon to total nitrogen (C:N) of about (22.4-5.6):1, and preferably about (16.8-11.2):1. In further embodiments, the disclosed compositions include molasses and a nitrogen source and do not have a molar ratio of total carbon to total nitrogen (C:N) of about (22.4-5.6):1. However, after these compositions not having a molar ratio of total carbon to total nitrogen (C:N) of about (22.4-5.6):1 are added to soil as an amendment, the amended soil has a molar ratio of total carbon to total nitrogen (C:N) of about (22.4-5.6): 1, and preferably about (16.8-11.2):1. In even further embodiments, the disclosed compositions do not include a nitrogen source and may be added to soil as an amendment in order to achieve in the amended soil a molar ratio of total carbon to total nitrogen (C:N) of about (22.4-5.6):1, and preferably about (16.8-11.2):1, for example, where the soil prior to amendment includes a nitrogen source.

Nitrogen sources may include organic nitrogen sources, inorganic nitrogen sources, or a mixture thereof. Suitable organic nitrogen sources may include, but are not limited to, urea, casein, and mixtures thereof. Addition suitable sources of organic nitrogen may include, but are not limited to, manure (e.g., dairy manure, cage manure including egg layers' manure, or mixtures thereof), hay (e.g., legume hay, grass hay, or mixtures thereof), and meal (e.g., alfalfa meal, soybean meal, blood meal, cottonseed meal, crab meal, fish meal, feather meal, or mixtures thereof). Suitable inorganic nitrogen sources may include, but are not limited to, ammonium salts (e.g., ammonium sulfate), nitrite salts, nitrate salts (e.g., potassium nitrate or ammonium nitrate), and mixtures thereof. Preferably, the nitrogen source may be readily assimilated by plants when the disclosed compositions are utilized as soil amendments. The nitrogen source may be added to the molasses composition as a solid or as a solution. The nitrogen source may be soluble in molasses or water.

Also disclosed are methods for preparing the disclosed compositions. The methods may include combining: (a) molasses, (b) one or more acids; and (c) one or more nitrogen sources to prepare the composition, wherein the composition has a molar ratio of total carbon to total nitrogen (C:N) of about (22.4-5.6):1. Optionally, the methods may include adjusting the pH of the composition to between about 4.0-7.0. Optionally, the methods may include adding a base to the composition (e.g., a hydroxide base) or any of the aforementioned additional components.

Also disclosed are methods for controlling soil-borne pests, weeds, or both around plants and/or for enhancing plant growth. The methods may include applying the disclosed compositions as a liquid soil amendment composition to plants or in soil around plant at an application rate of at least about (or no more than about) 5 ml/kg soil, 10 ml/kg soil, 20 ml/kg soil, 30 ml/kg soil, 40 ml/kg soil, or 50 ml/kg soil, for example, where the composition comprises 10% molasses and the method effectively applies the molasses at a rate of a least about (or no more than about) 0.5 g/kg soil, 1 g/kg soil, 2 g/kg soil, 3 g/kg soil, 4 g/kg soil, or 5 g/kg soil.

### BRIEF DESCRIPTION OF THE FIGURES

FIG. 1. Pre-plant number of nematodes [Rotylenchulus reniformis] per 100 mls soil versus application rate (g/kg soil) of BG (SolyVer U) or BSM (Solyver M) compositions.

FIG. 2. Pre-plant number of nematodes [Dorylaimida] per 100 mls soil versus application rate (g/kg soil) of BG (SolyVer U) or BSM (Solyver M) compositions.

FIG. 3. Pre-plant number of nematodes [Microbivorous] per 100 mls soil versus application rate (g/kg soil) of BG (SolyVer U) or BSM (Solyver M) compositions.

FIG. 4. Shoot height of seedlings (cm) versus application rate (g/kg soil) of BG (SolyVer U) or BSM (Solyver M) compositions at six (6) weeks post-planting.

FIG. 5. Weight of fresh shoots (g) versus application rate (g/kg soil) of BG (SolyVer U) or BSM (Solyver M) compositions at six (6) weeks post-planting.

FIG. 6. Mass of fresh shoots (g) versus amount (mls) of BG (SolyVer U) or BSM (Solyver M) compositions at six (6) weeks post-planting (regression analysis).

FIG. 7. Mass of fresh roots (g) versus application rate (g/kg soil) of BG (SolyVer U) or BSM (Solyver M) compositions at six (6) weeks post-planting.

FIG. 8. Root condition index versus application rate (g/kg soil) of BG (SolyVer U) or BSM (Solyver M) compositions at six (6) weeks post-planting.

FIG. 9. Final number of nematodes [Rotylenchulus reniformis] per 100 mls soil versus application rate (g/kg soil) of BG (SolyVer U) or BSM (Solyver M) compositions at six (6) weeks post-planting.

FIG. 10. Final number of nematodes [Rotylenchulus reniformis] per 100 mls soil versus amount (mls) of BG (SolyVer U) or BSM (Solyver M) compositions (regression analysis).

FIG. 11. Number of nematodes [Rotylenchulus reniformis] per mass of fresh root (g) versus application rate (g/kg soil) of BG (SolyVer U) or BSM (Solyver M) compositions.

FIG. 12. Number of nematodes [Rotylenchulus reniformis] per mass of fresh root (g) versus amount (mls) of BG (SolyVer U) or BSM (Solyver M) compositions (regression analysis).

FIG. 13. Final number of nematodes [Microbivorous] per 100 mls soil versus application rate (g/kg soil) of BG (SolyVer U) or BSM (Solyver M) compositions.

FIG. 14. Final number of nematodes [Microbivorous] per 100 mls soil versus amount (mls) of BG (SolyVer U) or BSM (Solyver M) compositions (regression analysis).

### DETAILED DESCRIPTION

The present invention is described herein using several definitions, as set forth below and throughout the application.

Unless otherwise specified, the terms “a” or “an” mean “one or more.” For example, the “an acid” should be interpreted to mean “one or more acids” or “at least one acid.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus 510% of the particular term and “substantially” and “significantly” will mean plus or minus >10% of the particular term, unless defined as otherwise herein.

As used herein, the terms “include” and “including” have the same meaning as the terms “comprise” and “comprising.” For example, “a method that includes a step” should be interpreted to mean “a method that comprises a step.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and permitting the inclusion only of additional components that do not fundamentally alter the nature of the claimed subject matter.

As used herein, “molasses” (alternatively “treacle”) is a by-product of sugar refining which may be further treated or left untreated. Suitable molasses for the disclosed compositions and methods may include molasses obtained from refining sugar from sugarcane (i.e., blackstrap molasses or “BSM”) or obtained from refining sugar from other sources (e.g. sugar beets).

The disclosed compositions include molasses and may be used as soil amendments that exhibit fertilizing activity. For example, the disclosed compositions may include one or more of assimilable potassium, phosphorus, and nitrogen. In some embodiments, the molasses is treated with a phosphorus-containing acid (e.g., phosphoric acid or phosphorous acid). In other embodiments, the molasses is treated with a potassium-containing base (e.g., KOH). In even further embodiments, a nitrogen source may be added to the molasses to provide a soil amendment composition having a suitable C:N ratio.

Incorporation into soil of organic matter with the appropriate C:N ratio is one of the best methods to suppress plant prasitic nematodes and other soil-bone pests. Stimulation of microbial activities in soil following incorporation of organic amendments has been repeatedly demonstrated to results in control of plant parasitic nematodes, a number of phytopathogenic fungi and even some insects and weeds. (Rodriguez-Kabana, R, and M. H. Pope, Nematropica 11: 175-186 (1986); Rodriguez-Kabana, R., G. Morgan-Jones, and T. Chet. 1987. Plant and Soil 100:237-247; Stirling, G. K 1991. Biological control of plant parasitic nematodes: progress, problem and prospects. Wallingford, Oxon, UK, CAB International, pp. 282; incorporated herein by reference in their entireties). Considerable research has been directed to the preparation of organic amendments based on agricultural wastes and other by-products of human activities, e.g., chicken and other manures, sewage and other urban ordures, in order to dispose of these materials in an environmentally acceptable manner (Stirling, 1991). In some embodiments, the disclosed compositions include a nitrogen source which may be an organic nitrogen source or an inorganic nitrogen source. Preferably, the nitrogen source is soluble in water or is soluble in molasses. The disclosed compositions may have a suitable C:N ratio (e.g., a C:N ration that about (22.4-5.6):1 or about (16.8-11.2):1).

The presently disclosed compositions typically include molasses and further may include other components that exhibit a fertilizing effect and/or a pesticidal effect (e.g., a nematocidal, a fungicidal, an herbicidal, or an insecticidal effect). In some embodiments, the disclosed compositions may include glycerin, for example, treated glycerin as disclosed in U.S. Pat. No. 8,519,009, the content of which is incorporated herein by reference in its entirety. The treated glycerin may have been treated optionally via adding acid to the glycerin and optionally by removing any precipitate from the treated glycerin.

As used herein, the phrase “effective amount” or “effective rate” shall mean that amount or rate that provides the specific response for which the composition is applied in a significant number of applications. The disclosed compositions may include an effective amount of the molasses to achieve a pesticidal effect (e.g., a nematocidal, a fungicidal, an herbicidal, or insecticidal effect) when applied at a given application rate.

The disclosed compositions may be utilized to control one or more pests (e.g. parasitic nematodes, fungi, and weeds). In some embodiments, the disclosed compositions are applied to soil at a given rate (e.g., for a 10% (w/w) formulation of molasses at a rate of at least about (or no more than about) 5 ml/kg soil, 10 ml/kg soil, about 20 ml/kg soil, 30 ml/kg soil, 40 ml/kg soil, or 50 ml/kg soil to effectively deliver at least about (or no more than about) 0.5 g/kg soil, 1 g/kg soil, 2 g/kg soil, 3 g/kg soil, 4 g/kg soil, or 5 g/kg soil) and reduce the pest population in the soil (e.g., parasitic nematodes as measured by number of pests/mls soil) by at least about 50% (or at least about 6) %., 70%, 80%, or 90%). In further embodiments, the disclosed compositions do not significantly reduce the population of beneficial nematodes present in the soil (e.g., microbivores or saprophagous nematodes), where the disclosed compositions are applied to soil at a rate as contemplated herein.

In some embodiments, the disclosed compositions may be prepared as follows: Optionally, add a potassium source to water; subsequently, add one or more acids to the water; then subsequently, add one or more nitrogen sources to the water; and then subsequently, add molasses to the water.

### ILLUSTRATIVE EMBODIMENTS

The following list of embodiments is illustrative and is not intended to limit the scope of the claimed subject matter.

Embodiment 1. A composition comprising: (a) molasses (optionally at a concentration of about 40-60% (w/w)); (b) one or more acids (optionally at a concentration of about 5-15% (w/w)); and (c) one or more nitrogen sources (optionally at a concentration of about 10-20% (w/w)); and optionally (d) water; wherein the composition has a molar ratio of total carbon to total nitrogen (C:N) of about (22.4-5.6):1 (or about (16.8-11.2): 1) and optionally has a pH of about 4.0-7.0.

Embodiment 2. The composition of embodiment 1, further comprising a phosphorus source (optionally at a concentration of about 1-3% (w/w)).

Embodiment 3. The composition of embodiment 1 or 2, further comprising a potassium source (optionally at a concentration of about 1-5% (w/w)).

Embodiment 4. The composition of any of the foregoing embodiments, wherein the acid is an organic acid (optionally at a concentration of about 5-15% (w/w)).

Embodiment 5. The composition of embodiment 4, wherein the organic acid comprises a carboxylic acid, a polycarboxyclic acid, or a polyhydroxycarboxylic acid (optionally at a concentration of about 5-15% (w/w)).

Embodiment 6. The composition of embodiment 5, wherein the carboxylic acid is selected from a group consisting of acetic acid, propionic acid, butyric acid, valeric acid and mixtures thereof (optionally at a concentration of about 5-15% (w/w)).

Embodiment 7. The composition of embodiment 5, wherein the polyhydroxycarboxylic acid is citric acid (optionally at a concentration of about 5-15% (w/w).

Embodiment 8. The composition of any of embodiments 1-3, wherein the acid is an inorganic acid (optionally at a concentration of about 1-3% (w/w)).

Embodiment 9. The composition of embodiment 8, wherein the inorganic acid is selected from a group consisting of phosphoric acid, sulfuric acid, and mixtures thereof (optionally at a concentration of about 1-3% (w/w)).

Embodiment 10. The composition of any of the foregoing embodiments, wherein the acid comprises a mixture of one or more organic acids and one or more inorganic acids (optionally at a concentration of about 5-15% (w/w)).

Embodiment 11. The composition of embodiment 10, wherein the organic acid comprises a carboxylic acid and the inorganic acid comprises phosphoric acid (optionally at a concentration of about 5-15% (w/w)).

Embodiment 12. The composition of embodiment 3, wherein the potassium source is potassium hydroxide (optionally at a concentration of about 1-5% (w/w)).

Embodiment 13. The composition of any of the foregoing embodiments, wherein the nitrogen source comprises urea (optionally at a concentration of about 10-20% (w/w)).

Embodiment 14. The composition of any of the foregoing embodiments, comprising: (a) molasses (optionally at a concentration of about 40-60% (w/w)); (b) propionic acid (optionally at a concentration of about 5-15% (w/w)): (c) phosphoric acid (optionally at a concentration of about 1-3% (w/w)); (d) potassium hydroxide (optionally at a concentration of about 1-5% (w/w)); (e) urea (optionally at a concentration of about 10-20% (w/w)); and optionally (f) water; wherein the composition has a molar ratio of total carbon to total nitrogen (C:N) of about (22.4-5.6):1 and the composition optionally has a pH of about 4.0-7.0.

Embodiment 15. The composition of any of the foregoing embodiments, further comprising glycerin (optionally glycerin obtained as a by-product of a biodiesel reaction where optionally the glycerin has been treated by adding an acid to the glycerin and removing any precipitate in the treated glycerin).

Embodiment 16. The composition of any of the foregoing embodiments, further comprising a sulfate salt (e.g., ammonium thiosulfate)

Embodiment 17. The composition of any of the foregoing embodiments, further comprising a guanidine salt (e.g., guanidine hydrochloride).

Embodiment 18. The composition of any of the foregoing embodiments, further comprising a cyanamide salt (e.g., sold under the trademark Dormex®).

Embodiment 19. A method for controlling soil born pests and/or weeds and/or for enhancing growth of plants, the method comprising applying any of the foregoing compositions to soil at an application rate that delivers 0.5-5.0 g/kg soil of molasses.

Embodiment 20. A method for preparing a composition, the method comprising combining: (a) molasses; (b) one or more acids; (c) one or more nitrogen source to prepare the composition; and optionally (d) water; wherein the composition has a molar ratio of total carbon to total nitrogen (C:N) of about (22.4-5.6):1 and optionally the composition has a pH of about 4.0-7.0.

### EXAMPLES

The following examples are illustrative and are not intended to limit the scope of the claimed subject matter.

### Example 1

### Preparation of Soil Amendment Compositions Comprising Blackstrap Molasses

Solution compositions as contemplated herein may be prepared generally as follows. Add potassium hydroxide to water. Subsequently add phosphoric acid to the water and then subsequently add propionic acid to the water. Subsequently add urea the water. Then subsequently add blackstrap molasses (BSM) and/or biodiesel glycerin (BG) to the water.

Water (120 mls) was placed in an Erlenmeyer flask and the following components were added to the flask in succession with thorough mixing after each component was added: 45% KOH (57 g); 75% phosphoric acid (23.9 g); and propionic acid (69.5 g). The contents generated heat to about 70° C. Urea (110 g of prilled fertilizer grade) then was added to the flask which had a cooling effect on the contents of the flask. After thorough mixing, the urea went into solution and blackstrap molasses (BSG) (436 g) and/or biodiesel glycerin (BG) (436 g) was added to the flask. Because the prilled fertilizer grade urea contains a small amount of dispersing solid agent which is not soluble, the solution thus prepared contained a small amount of sediment. The solutions thus prepared are stable for a year or more when kept in a tightly closed container at ordinary temperatures (<30° F.).

Additional ingredients such as Dormex® brand hydrogen cyanamide, ammonium thiosulfate, and guanidine hydrochloride were utilized to prepare various formulations as indicated below:

| | | SOLYVER | SOLYVER | SOLYVER | | SOLYVER | SOLYVER | SOLYVER |
|---|---|---|---|---|---|---|---|---|
| | SOLYVER U | M or MU | M ATS | MG | SOLYVER G | CD | ATS | M CD |
| WATER | 120 | 120 | 120 | 120 | 120 | 120 | 120 | 120 |
| 45% KOH | 57 | 57 | 57 | 57 | 57 | 57 | 57 | 57 |
| 75% H₃PO₄ | 23.9 | 23.9 | 23.9 | 23.9 | 23.9 | 23.9 | 23.9 | 23.9 |
| C₂H₅COOH | 69.5 | 69.5 | 69.5 | 69.5 | 69.5 | 69.5 | 69.5 | 69.5 |
| UREA | 110 | 110 (MU) | 0 | 0 | 0 | 0 | 0 | 0 |
| CN₂H₂* | 0 | 0 | 0 | 0 | 0 | 100 | 0 | 100 |
| (NH₄)₂(S₂O₃) | 0 | 0 | 200 | 0 | 0 | 0 | 200 | 0 |
| GUANIDINE | 0 | 0 | 0 | 76 | 76 | 0 | 0 | 0 |
| HCL | | | | | | | | |
| [BG] | 436 | 0 | 0 | 0 | 436 | 436 | 436 | 0 |
| [BSM] | 0 | 436 | 436 | 436 | | | | 436 |

All FIGURES are in grams.
*DORMEX ® brand hydrogen cyanamide containing 50% (weight) of the compound.

### Example 2

### Use of Molasses Formulations as a Soil Amendment for Modifying Growth of Nematodes

The pesticidal efficacy of formulations of sugarcane black strap molasses as prepared in Example 1 were studied in greenhouse experiments. Formulations contained nitrogen, phosphorus, and potassium. The soil for the experiment was a sandy loam from a cotton [Gossypium hirsutum] field infested with a reniform nematode [Rotylenchulus reniformus]. The formulations were applied by drenching into the soil contained in 1 liter pots which were covered immediately after application with transparent low density polyethylene bags for 10 days. The bags were removed 10 days after application and soil samples were taken for nematode analysis using the salad bowl incubation technique [SBIT]. Each pot was planted with 5 cucumber seeds [Cucumis sativus] and the resulting plants were grown for six (6) weeks at which time they were removed from the soil for growth analyses including shoot height, shoot weight, and root weight. Final soil samples also were collected at six (6) weeks for nematode analysis. Shoot heights and the weights of fresh shoots and roots were recorded and roots were incubated [SBIT] to determine nematode populations. All formulations of BSM and BG applied in the range of >2 g/kg soil resulted in significant reductions in populations of R. reniformis. Numbers of dorylaimida nematodes were unaffected by BG applications at <2 g/kg soil. However, dorylaimida nematodes were eliminated by BSM at all application rates and by BG at >2 g/kg soil. Populations of microbivorous/saprophagous nematodes were increased exponentially by the BG treatments but to a much lesser degree by those with BSM. Values for shoot height, and fresh weights of shoots and roots were improved proportionately to the application rates of BSM and BG formulations. The results are presented in Tables 1-16 and FIGS. 1-14.

TABLE 1
Pre-plant assessment of nematodes
twenty (20) days post-treatment with formulation.
Nematodes/100 cm³ soil

| | | mls 10% | | | |
|---|---|---|---|---|---|
| | | (w/w) | | | |
| | | solution | | | |
| | Treatment | per pot | Reniform | Dorylaimoid | Saprophagous |
| 1. | Control | 0 | 719.6 | 4.3 | 65.3 |
| 2. | SOLYVER | 5 | 1063.0 | 4.3 | 98.3 |
| | U | | | | |
| 3. | | 10 | 953.3 | 6.0 | 130.1 |
| 4. | | 20 | 825.7 | 5.3 | 240.7 |
| 5. | | 30 | 361.4 | 0.0 | 644.4 |
| 6 | | 40 | 88.3 | 0.0 | 783.4 |
| 7. | | 50 | 17.3 | 0.0 | 477.3 |
| 8. | SOLYVER | 5 | 765.4 | 4.6 | 52.4 |
| | MU | | | | |
| 9. | | 10 | 685.6 | 1.4 | 61.4 |
| 10. | | 20 | 486.0 | 0.4 | 170.0 |
| 11. | | 30 | 52.6 | 1.1 | 256.6 |
| 12. | | 40 | 4.3 | 0.0 | 150.7 |
| 13. | | 50 | 3.0 | 9.0 | 91.1 |
| 14. | Control | 0 | 665.6 | 3.6 | 70.1 |

| | | | |
|---|---|---|---|
| LSD (P = 0.05) = | 153.96 | 3.14 | 106.54 |

TABLE 2
Analysis of cucumber seedlings thirty-five (35) days post-
planting.

| | | mls 10% | Number | Shoot | Shoot | Root | |
|---|---|---|---|---|---|---|---|
| | | (w/w) solution | of | Height | Weight | Weight | Root¹ |
| | Treatment | per pot | Plants | (cm) | (g) | (g) | Condition |
| 1. | Control | 0 | 4.9 | 19.1 | 14.6 | 8.9 | 2.4 |
| 2. | SOLYVER U | 5 | 4.4 | 27.3 | 26.4 | 6.6 | 1.4 |
| 3. | | 10 | 5.0 | 28.7 | 28.3 | 6.5 | 1.4 |
| 4. | | 20 | 4.6 | 36.7 | 41.5 | 8.1 | 1.0 |
| 5. | | 30 | 4.6 | 41.1 | 39.5 | 7.8 | 1.1 |
| 6. | | 40 | 4.4 | 47.6 | 47.7 | 7.4 | 1.6 |
| 7. | | 50 | 4.7 | 54.1 | 57.2 | 8.7 | 1.6 |
| 8. | SOLYVER MU | 5 | 4.9 | 84.6 | 28.8 | 6.6 | 1.7 |
| 9. | | 10 | 4.6 | 36.9 | 36.3 | 8.5 | 1.0 |
| 10. | | 20 | 4.9 | 43.4 | 45.7 | 10.4 | 1.0 |
| 11. | | 30 | 4.9 | 46.3 | 45.4 | 9.4 | 1.1 |
| 12. | | 40 | 4.6 | 51.1 | 48.1 | 11.4 | 1.0 |
| 13. | | 50 | 4.9 | 47.4 | 47.4 | 14.5 | 1.0 |
| 14. | Control | 0 | 4.7 | 22.8 | 13.0 | 3.2 | 3.0 |

| | | | | | |
|---|---|---|---|---|---|
| LSD (P = 0.05) = | 0.67 | 6.70 | 9.28 | 2.37 | 0.43 |

¹Root Condition Scale: 1 = Best; 5 = Worst

TABLE 3
Post-plant assessment of nematodes thirty-five (35) days post-planting.
Nematodes/100 cm³ soil

| | | mls 10% | | | |
|---|---|---|---|---|---|
| | | (w/w) | | | |
| | | solution | | | |
| | Treatment | per pot | Reniform | Dorylaimoid | Saprophagous |
| 1. | Control | 0 | 936.9 | 29.1 | 151.3 |
| 2. | SOLYVER | 5 | 1301.4 | 28.4 | 236.1 |
| | U | | | | |
| 3. | | 10 | 1225.9 | 32.7 | 229.1 |
| 4. | | 20 | 1601.7 | 18.3 | 180.6 |
| 5. | | 30 | 1816.3 | 2.9 | 152.9 |
| 6. | | 40 | 978.0 | 0.0 | 148.6 |
| 7. | | 50 | 216.0 | 0.0 | 324.6 |
| 8. | SOLYVER | 5 | 684.4 | 34.4 | 252.0 |
| | MU | | | | |
| 9. | | 10 | 1397.3 | 12.9 | 195.9 |
| 10. | | 20 | 2096.4 | 3.9 | 65.3 |
| 11. | | 30 | 758.9 | 3.0 | 107.4 |
| 12. | | 40 | 184.4 | 0.0 | 405.0 |
| 13. | | 50 | 90.1 | 0.0 | 274.3 |
| 14. | Control | 0 | 740.9 | 14.6 | 116.7 |

| | | | |
|---|---|---|---|
| LSD (P = 0.05) = | 350.85 | 7.26 | 79.65 |

TABLE 4
Post-plant assessment of nematodes thirty-five (35) days post-
planting.

| | | mls 10% | Nematodes/Total | | Nematodes/g | |
|---|---|---|---|---|---|---|
| | | (w/w) solution | Roots | | root | |
| | Treatment | per pot | Reniform | Saprophagous | Reniform | Saprophagous |
| 1. | Control | 0 | 271.9 | 15.3 | 73.3 | 4.1 |
| 2. | SOLYVER U | 5 | 532.6 | 27.8 | 88.4 | 4.4 |
| 3. | | 10 | 667.6 | 13.7 | 117.4 | 2.7 |
| 4. | | 20 | 649.1 | 12.0 | 84.3 | 1.4 |
| 5. | | 30 | 695.1 | 21.1 | 109.9 | 3.0 |
| 6. | | 40 | 417.7 | 12.3 | 80.3 | 2.4 |
| 7. | | 50 | 123.4 | 10.1 | 16.0 | 10.1 |
| 8. | SOLYVER MU | 5 | 485.6 | 17.1 | 75.4 | 2.6 |
| 9. | | 10 | 587.0 | 7.7 | 82.7 | 0.9 |
| 10. | | 20 | 654.9 | 8.6 | 64.6 | 0.9 |
| 11. | | 30 | 486.7 | 13.9 | 52.0 | 1.6 |
| 12. | | 40 | 114.7 | 17.7 | 9.4 | 2.0 |
| 13. | | 50 | 46.6 | 27.9 | 3.0 | 1.9 |
| 14. | Control | 0 | 189.3 | 18.1 | 59.0 | 4.1 |

| | | | | |
|---|---|---|---|---|
| LSD (P = 0.05) = | 220.4 | 8.59 | 46.0 | 1.44 |

TABLE 5
Pre-plant assessment of nematodes
fifteen (15) days post-treatment with formulation.
Nematodes/100 cm³ soil

| | | mls 10% | | | |
|---|---|---|---|---|---|
| | | (w/w) | | | |
| | | solution | | | |
| | Treatment | per pot | Reniform | Dorylaimoid | Saprophagous |
| 1. | Control | 0 | 720.4 | 8.6 | 145.1 |
| 2. | SOLYVER | 5 | 643.6 | 3.6 | 214.7 |
| | ATS | | | | |
| 3. | | 10 | 555.0 | 0.0 | 266.1 |
| 4. | | 20 | 406.9 | 0.0 | 174.1 |
| 5. | | 30 | 344.4 | 0.0 | 177.1 |
| 6. | | 40 | 318.1 | 0.0 | 313.1 |
| 7. | | 50 | 157.7 | 0.0 | 324.6 |
| 8. | SOLYVER | 5 | 436.1 | 0.4 | 150.0 |
| | MATS | | | | |
| 9. | | 10 | 527.7 | 0.1 | 162.9 |
| 10. | | 20 | 403.1 | 0.0 | 130.1 |
| 11. | | 30 | 299.7 | 0.0 | 74.3 |
| 12. | | 40 | 144.9 | 0.0 | 95.9 |
| 13. | | 50 | 48.1 | 0.0 | 116.0 |
| 14. | Control | 0 | 484.9 | 4.9 | 87.9 |

| | | | |
|---|---|---|---|
| LSD (P = 0.05) = | 122.46 | 2.65 | 84.97 |

TABLE 6
Analysis of cucumber seedlings thirty-five (35) days post-planting.
Nematodes/100 cm³ soil

| | | mls 10% | | | |
|---|---|---|---|---|---|
| | | (w/w) | | | |
| | | solution | | | |
| | Treatment | per pot | Reniform | Dorylaimoid | Saprophagous |
| 1. | Control | 0 | 1530.1 | 7.7 | 346.9 |
| 2. | SOLYVER | 5 | 2086.0 | 7.6 | 302.1 |
| | ATS | | | | |
| 3. | | 10 | 2442.0 | 1.0 | 89.1 |
| 4. | | 20 | 995.1 | 0.0 | 136.9 |
| 5. | | 30 | 913.3 | 0.3 | 115.9 |
| 6. | | 40 | 785.7 | 0.0 | 69.4 |
| 7. | | 50 | 764.0 | 0.0 | 86.9 |
| 8. | SOLYVER | 5 | 1823.6 | 8.4 | 117.4 |
| | MATS | | | | |
| 9. | | 10 | 1910.4 | 8.4 | 142.0 |
| 10. | | 20 | 981.7 | 1.3 | 119.9 |
| 11. | | 30 | 653.3 | 0.0 | 210.1 |
| 12. | | 40 | 655.1 | 0.0 | 148.1 |
| 13. | | 50 | 448.6 | 0.0 | 143.1 |
| 14. | Control | 0 | 999.1 | 6.0 | 188.1 |

| | | | |
|---|---|---|---|
| LSD (P = 0.05) = | 398.08 | 2.67 | 76.85 |

TABLE 7
Post-plant assessment of nematodes thirty-five (35) days post-planting.

| | | mls 10% | Nematodes/ | | | |
|---|---|---|---|---|---|---|
| | | (w/w) solution | Total Roots | | Nematodes/g Root | |
| | Treatment | per pot | Reniform | Saprophagous | Reniform | Saprophagous |
| 1. | Control | 0 | 511.6 | 26.7 | 206.1 | 9.9 |
| 2. | SOLYVER ATS | 5 | 896.1 | 15.9 | 190.9 | 3.4 |
| 3. | | 10 | 966.1 | 20.4 | 143.1 | 3.1 |
| 4. | | 20 | 408.9 | 19.3 | 54.1 | 2.6 |
| 5. | | 30 | 299.7 | 19.4 | 37.4 | 2.4 |
| 6. | | 40 | 470.3 | 17.9 | 85.9 | 3.0 |
| 7. | | 50 | 400.9 | 12.6 | 144.7 | 5.4 |
| 8. | SOLYVER MATS | 5 | 708.9 | 16.1 | 153.6 | 3.4 |
| 9. | | 10 | 697.0 | 14.7 | 113.6 | 2.4 |
| 10. | | 20 | 510.0 | 11.0 | 52.7 | 0.9 |
| 11. | | 30 | 339.0 | 15.6 | 31.4 | 1.4 |
| 12. | | 40 | 362.7 | 26.7 | 88.9 | 3.7 |
| 13. | | 50 | 126.0 | 15.0 | 12.7 | 1.4 |
| 14. | Control | 0 | 206.4 | 13.4 | 64.0 | 4.3 |

| | | | | |
|---|---|---|---|---|
| LSD (P = 0.05) = | 226.92 | 8.98 | 71.84 | 2.82 |

TABLE 8
Post-plant assessment of nematodes thirty-five (35) days post-planting.

| | | mls 10% | Number | Shoot | Shoot | Root | |
|---|---|---|---|---|---|---|---|
| | | (w/w) solution | of | Height | Weight | Weight | Root¹ |
| | Treatment | per pot | Plants | (cm) | (g) | (g) | Condition |
| 1. | Control | 0 | 4.4 | 18.0 | 11.0 | 2.6 | 3.0 |
| 2. | SOLYVER ATS | 5 | 4.4 | 22.3 | 19.9 | 4.8 | 2.1 |
| 3. | | 10 | 5.0 | 28.5 | 29.5 | 6.8 | 1.3 |
| 4. | | 20 | 4.9 | 38.1 | 36.9 | 7.6 | 1.0 |
| 5. | | 30 | 4.9 | 40.1 | 39.1 | 8.4 | 1.0 |
| 6. | | 40 | 4.6 | 42.0 | 31.6 | 7.7 | 1.3 |
| 7. | | 50 | 4.0 | 36.2 | 27.7 | 6.7 | 1.6 |
| 8. | SOLYVER MATS | 5 | 4.7 | 24.7 | 21.5 | 4.9 | 1.6 |
| 9. | | 10 | 4.9 | 30.7 | 27.6 | 6.2 | 1.6 |
| 10. | | 20 | 4.6 | 35.7 | 37.9 | 10.5 | 1.0 |
| 11. | | 30 | 4.4 | 38.9 | 39.2 | 11.9 | 1.0 |
| 12. | | 40 | 3.7 | 42.6 | 33.0 | 10.0 | 1.4 |
| 13. | | 50 | 3.9 | 38.9 | 35.9 | 10.8 | 1.3 |
| 14. | Control | 0 | 4.7 | 17.9 | 10.5 | 3.2 | 3.0 |

| | | | | | |
|---|---|---|---|---|---|
| LSD (P = 0.05) = | 0.86 | 3.64 | 5.96 | 2.87 | 0.42 |

¹Root Condition Scale: 1 = Best: 5 = Worst

TABLE 9
Pre-plant assessment of nematodes ten (10) days post-treatment
with formulation.
Nematodes/100 cm³ soil

| | | mls 10% | | | |
|---|---|---|---|---|---|
| | | solution/ | | | |
| | Treatment | kg soil | Reniform | Dorylaimoid | Saprophagous |
| 1. | Control | 0 | 612.3 | 2.0 | 40.8 |
| 2. | Solyver MU | 5 | 578.3 | 0.3 | 47.1 |
| 3. | | 10 | 376.7 | 1.4 | 83.1 |
| 4. | | 20 | 228.0 | 0.0 | 170.0 |
| 5. | | 30 | 197.3 | 0.0 | 230.3 |
| 6. | | 40 | 84.1 | 0.0 | 506.7 |
| 7. | | 50 | 32.3 | 0.0 | 170.0 |
| 8. | Solyver | 5 | 513.7 | 0.4 | 48.6 |
| | MCD | | | | |
| 9. | | 10 | 417.3 | 0.0 | 41.6 |
| 10. | | 20 | 293.4 | 0.0 | 122.9 |
| 11. | | 30 | 124.3 | 0.0 | 192.1 |
| 12. | | 40 | 7.9 | 0.0 | 118.0 |
| 13. | | 50 | 3.8 | 0.0 | 128.1 |
| 14. | Control | 0 | 628.7 | 1.4 | 89.3 |

| | | | |
|---|---|---|---|
| LSD (P = 0.05) = | 111.87 | 1.26 | 103.54 |

TABLE 10
Analysis of cucumber seedlings thirty (30) days post-planting.

| | | mls 10% | Number | Shoot | Shoot | Root | |
|---|---|---|---|---|---|---|---|
| | | solution/ | of | Height | Weight | Weight | Root¹ |
| | Treatment | kg soil | Plants | (cm) | (g) | (g) | Condition |
| 1. | Control | 0 | 4.3 | 18.3 | 15.4 | 6.4 | 2.0 |
| 2. | Solyver MU | 5 | 4.0 | 20.7 | 22.4 | 8.1 | 2.3 |
| 3. | | 10 | 4.7 | 24.5 | 20.4 | 9.3 | 1.4 |
| 4. | | 20 | 4.7 | 33.3 | 35.6 | 12.2 | 1.0 |
| 5. | | 30 | 4.7 | 37.8 | 41.4 | 11.4 | 1.0 |
| 6. | | 40 | 4.7 | 43.1 | 50.9 | 12.8 | 1.4 |
| 7. | | 50 | 4.7 | 41.3 | 44.1 | 15.2 | 1.0 |
| 8. | Solyver MCD | 5 | 4.8 | 25.1 | 20.1 | 7.4 | 2.3 |
| 9. | | 10 | 4.4 | 24.8 | 20.8 | 7.0 | 2.0 |
| 10. | | 20 | 4.7 | 34.9 | 38.6 | 11.6 | 1.0 |
| 11. | | 30 | 5.0 | 40.0 | 46.9 | 12.8 | 1.1 |
| 12. | | 40 | 4.6 | 41.7 | 46.5 | 14.1 | 1.0 |
| 13. | | 50 | 5.0 | 44.0 | 60.4 | 17.5 | 1.1 |
| 14. | Control | 0 | 4.3 | 24.0 | 16.2 | 6.4 | 2.3 |

| | | | | | |
|---|---|---|---|---|---|
| LSD (P = 0.05) = | 0.04 | 3.05 | 6.58 | 2.05 | 0.38 |

¹Root Condition Scale: 1 = Best: 5 = Worst

TABLE 11
Post-plant assessment of nematodes thirty (30) days post-planting.
Nematodes/100 cm³ soil

| | | mls 10% | | | |
|---|---|---|---|---|---|
| | | solution/ | | | |
| | Treatment | kg soil | Reniform | Dorylaimoid | Saprophagous |
| 1. | Control | 0 | 720.4 | 4.6 | 47.1 |
| 2. | Solyver MU | 5 | 409.7 | 0.0 | 69.8 |
| 3. | | 10 | 512.9 | 0.0 | 100.6 |
| 4. | | 20 | 446.6 | 0.0 | 91.7 |
| 5. | | 30 | 464.1 | 0.0 | 160.7 |
| 6. | | 40 | 410.4 | 0.0 | 105.1 |
| 7. | | 50 | 341.0 | 0.0 | 280.0 |
| 8. | Solyver | 5 | 504.6 | 2.4 | 44.9 |
| | MCD | | | | |
| 9. | | 10 | 461.6 | 1.0 | 98.1 |
| 10. | | 20 | 278.0 | 0.0 | 183.1 |
| 11. | | 30 | 289.8 | 0.0 | 221.9 |
| 12. | | 40 | 146.8 | 0.0 | 276.3 |
| 13. | | 50 | 160.7 | 0.0 | 272.3 |
| 14. | Control | 0 | 532.7 | 2.0 | 37.9 |

| | | | |
|---|---|---|---|
| LSD (P = 0.05) = | 172.70 | 1.55 | 67.59 |

TABLE 12
Post-plant assessment of nematodes thirty (30) days post-planting.

| | | mls 10% | | | | | | |
|---|---|---|---|---|---|---|---|---|
| | | solution/ | Nematodes/Total Roots | | | Nematodes/g Root | | |
| | Treatment | kg soil | Reniform | Lesion | Saprophagous | Reniform | Lesion | Saprophagous |
| 1. | Control | 0 | 470.3 | 32.6 | 18.3 | 78.0 | 5.3 | 3.0 |
| 2. | Solyver MU | 5 | 311.6 | 35.0 | 18.3 | 56.1 | 4.7 | 2.3 |
| 3. | | 10 | 217.6 | 22.0 | 11.7 | 24.9 | 2.6 | 1.3 |
| 4. | | 20 | 190.7 | 22.0 | 16.3 | 18.0 | 1.7 | 1.6 |
| 5. | | 30 | 117.0 | 16.9 | 37.3 | 10.6 | 1.4 | 3.9 |
| 6. | | 40 | 113.4 | 3.3 | 23.3 | 8.9 | 0.1 | 1.9 |
| 7. | | 50 | 65.3 | 1.7 | 19.4 | 4.1 | 0.1 | 1.1 |
| 8. | Solyver MCD | 5 | 279.4 | 67.3 | 22.1 | 42.7 | 8.0 | 2.9 |
| 9. | | 10 | 219.7 | 20.3 | 19.3 | 35.4 | 3.1 | 3.1 |
| 10. | | 20 | 50.9 | 18.1 | 40.0 | 4.6 | 1.6 | 4.0 |
| 11. | | 30 | 24.0 | 3.7 | 20.0 | 1.6 | 0.1 | 1.6 |
| 12. | | 40 | 50.4 | 5.0 | 21.9 | 4.0 | 0.3 | 1.7 |
| 13. | | 50 | 21.6 | 1.3 | 20.1 | 1.1 | 0.0 | 1.1 |
| 14. | Control | 0 | 303.6 | 39.4 | 14.4 | 51.4 | 6.1 | 2.6 |

| | | | | | | |
|---|---|---|---|---|---|---|
| LSD (P = 0.05) = | 149.59 | 17.86 | 19.54 | 32.28 | 2.25 | 2.34 |

TABLE 13
Pre-plant assessment of nematodes
twelve (12) days post-treatment with formulation.
Nematodes/100 cm³ soil

| | | mls 10% | | | |
|---|---|---|---|---|---|
| | | solution/ | | | |
| | Treatment | kg soil | Reniform | Dorylaimoid | Saprophagous |
| 1. | Control | 0 | 1160.9 | 2.1 | 40.6 |
| 2. | Solyver MG | 5 | 255.3 | 0.6 | 45.6 |
| 3. | | 10 | 70.1 | 0.0 | 84.1 |
| 4. | | 20 | 6.4 | 0.0 | 127.7 |
| 5. | | 30 | 0.0 | 0.0 | 21.9 |
| 6. | | 40 | 0.0 | 0.0 | 43.6 |
| 7. | | 50 | 0.0 | 0.0 | 15.1 |
| 8. | Solyver | 5 | 264.9 | 0.0 | 52.7 |
| | MCD | | | | |
| 9. | | 10 | 27.1 | 0.0 | 80.1 |
| 10. | | 20 | 0.7 | 0.0 | 5.0 |
| 11. | | 30 | 0.0 | 0.0 | 5.7 |
| 12. | | 40 | 0.0 | 0.0 | 1.8 |
| 13. | | 50 | 0.0 | 0.0 | 0.0 |
| 14. | Control | 0 | 710.6 | 2.7 | 42.7 |

| | | | |
|---|---|---|---|
| LSD (P = 0.05) = | 101.51 | 0.92 | 34.65 |

TABLE 14
Analysis of cucumber seedlings thirty-five (35) days post-planting.

| | | mls 10% | Number | Shoot | Shoot | Root | |
|---|---|---|---|---|---|---|---|
| | | solution/ | of | Height | Weight | Weight | Root¹ |
| | Treatment | kg soil | Plants | (cm) | (g) | (g) | Condition |
| 1. | Control | 0 | 4.9 | 16.4 | 11.0 | 2.4 | 3.7 |
| 2. | Solyver MG | 5 | 4.7 | 16.2 | 15.5 | 3.8 | 2.7 |
| 3. | | 10 | 4.7 | 15.6 | 11.0 | 3.1 | 2.0 |
| 4. | | 20 | 4.6 | 13.2 | 9.5 | 1.9 | 3.9 |
| 5. | | 30 | 4.0 | 12.0 | 7.2 | 1.4 | 4.0 |
| 6. | | 40 | 2.3 | 12.1 | 4.2 | 1.2 | 4.1 |
| 7. | | 50 | 3.4 | 12.0 | 6.0 | 1.0 | 4.0 |
| 8. | Solyver MCD | 5 | 4.3 | 17.2 | 11.8 | 2.5 | 3.0 |
| 9. | | 10 | 4.4 | 21.8 | 21.4 | 4.7 | 2.1 |
| 10. | | 20 | 4.6 | 26.9 | 20.9 | 6.7 | 1.4 |
| 11. | | 30 | 3.0 | 30.7 | 40.0 | 10.3 | 1.0 |
| 12. | | 40 | 3.3 | 36.6 | 34.4 | 9.4 | 1.0 |
| 13. | | 50 | 4.0 | 36.2 | 47.2 | 10.8 | 1.0 |
| 14. | Control | 0 | 4.3 | 21.8 | 16.1 | 4.6 | 0.0 |

| | | | | | |
|---|---|---|---|---|---|
| LSD (P = 0.05) = | 0.99 | 2.76 | 0.25 | 1.42 | 0.42 |

¹Root Condition Scale: 1 = Best: 5 = Worst

TABLE 15
Post-plant assessment of nematodes thirty-five (35) days post-planting.
Nematodes/100 cm³ soil

| | | mls 10% | | | |
|---|---|---|---|---|---|
| | | solution/ | | | |
| | Treatment | kg soil | Reniform | Dorylaimoid | Saprophagous |
| 1. | Control | 0 | 854.6 | 9.7 | 147.7 |
| 2. | Solyver MG | 5 | 947.4 | 8.5 | 256.8 |
| 3. | | 10 | 191.4 | 0.0 | 288.7 |
| 4. | | 20 | 10.0 | 0.0 | 287.9 |
| 5. | | 30 | 0.0 | 0.0 | 829.1 |
| 6. | | 40 | 0.0 | 0.0 | 274.6 |
| 7. | | 50 | 0.0 | 0.0 | 348.6 |
| 8. | Solyver | 5 | 1020.7 | 1.9 | 115.4 |
| | MCD | | | | |
| 9. | | 10 | 593.9 | 0.0 | 146.0 |
| 10. | | 20 | 62.3 | 0.0 | 83.6 |
| 11. | | 30 | 32.7 | 0.0 | 100.7 |
| 12. | | 40 | 19.8 | 0.0 | 208.0 |
| 13. | | 50 | 24.3 | 0.0 | 144.7 |
| 14. | Control | 0 | 1130.4 | 3.0 | 99.4 |

| | | | |
|---|---|---|---|
| LSD (P = 0.05) = | 149.06 | 1.79 | 229.90 |

TABLE 16
Post-plant assessment of nematodes thirty-five (35) days post-planting.

| | | mls 10% | | | | | | |
|---|---|---|---|---|---|---|---|---|
| | | solution/ | Nematodes/Total_Roots | | | Nematodes/g Root | | |
| | Treatment | kg soil | Reniform | Lesion | Saprophagous | Reniform | Lesion | Saprophagous |
| 1. | Control | 0 | 343.6 | 70.1 | 42.7 | 158.1 | 32.8 | 18.7 |
| 2. | Solyver MG | 5 | 384.7 | 113.1 | 31.4 | 108.7 | 31.3 | 8.4 |
| 3. | | 10 | 79.1 | 67.3 | 67.9 | 26.1 | 18.7 | 12.4 |
| 4. | | 20 | 13.7 | 17.4 | 8.7 | 7.0 | 9.1 | 4.7 |
| 5. | | 30 | 0.0 | 1.7 | 3.4 | 0.0 | 1.1 | 2.4 |
| 6. | | 40 | 0.0 | 0.3 | 10.3 | 0.0 | 0.3 | 0.9 |
| 7. | | 50 | 0.0 | 0.0 | 0.1 | 0.0 | 0.0 | 0.0 |
| 8. | Solyver MCD | 3 | 354.3 | 79.6 | 23.6 | 133.4 | 32.6 | 9.9 |
| 9. | | 10 | 191.0 | 20.0 | 26.9 | 42.7 | 3.6 | 5.4 |
| 10. | | 20 | 15.6 | 0.3 | 8.0 | 2.1 | 0.0 | 1.3 |
| 11. | | 30 | 4.3 | 2.0 | 24.1 | 0.6 | 0.1 | 2.6 |
| 12. | | 40 | 9.6 | 1.6 | 4.6 | 1.9 | 0.3 | 0.7 |
| 13. | | 50 | 0.0 | 0.0 | 2.7 | 0.0 | 0.0 | 0.1 |
| 14. | Control | 0 | 325.6 | 72.0 | 47.9 | 80.7 | 16.9 | 11.3 |

| | | | | | | |
|---|---|---|---|---|---|---|
| LSD (P = 0.05) = | 97.12 | 22.13 | 14.01 | 39.53 | 8.20 | 5.75 |

### Example 3

### Molasses Formulations for Controlling or Eliminating Weeds

The formulations of Example 1 and Example 2 were tested in regard to efficacy for controlling or eliminating weeds, including yellow nutsedge, crabgrass, teaweed, sicklepod, morning glory, and other weeds. A 10% solution was applied to soil at rates of 5 mls/kg soil, 10 mls/kg soil, 20 m/s/kg soil, 30 m/s/kg soil, 40 m/s/kg soil, and 50 mls/kg soil, effectively delivering 0.5 g/kg soil, 1 g/kg soil, 2 g/kg soil, 3 g/kg soil, 40 g/kg soil, and g/kg soil. The soil then was planted with a standard weed pack of seeds including seeds of the aforementioned weeds. Emerging weeds were counted three times after approximately 1, 2, and 3 weeks, respectively. (See Tables 17-25). Application rates of as low as 10 mls/kg soil (1 g/kg) were found to be effective for reducing emerging weeds.

TABLE 17
First count of emerging weeds at six (6) days post-planting.

| | | mls 10% | | | | | | | |
|---|---|---|---|---|---|---|---|---|---|
| | | (w/w) solution | Yellow | | | | Morning- | Other | Total |
| | Treatment | per pot | Nutsedge | Crabgrass | Teaweed | Sicklepod | glory | Weeds | Weeds |
| 1. | Control | 0 | 0.1 | 0.3 | 8.1 | 1.4 | 3.1 | 2.0 | 15.1 |
| 2. | SOLYVER U | 5 | 0.1 | 0.6 | 8.4 | 1.1 | 4.1 | 1.6 | 16.0 |
| 3. | | 10 | 0.0 | 0.1 | 10.0 | 0.6 | 6.0 | 0.7 | 17.4 |
| 4. | | 20 | 0.3 | 0.1 | 5.9 | 0.7 | 1.3 | 0.4 | 8.7 |
| 5. | | 30 | 0.3 | 0.0 | 0.7 | 0.7 | 0.3 | 0.0 | 2.0 |
| 6. | | 40 | 0.0 | 0.0 | 0.0 | 0.0 | 0.7 | 0.0 | 0.7 |
| 7. | | 50 | 0.0 | 0.0 | 0.0 | 0.0 | 0.0 | 0.0 | 0.0 |
| 8. | SOLYVER MU | 5 | 0.3 | 0.3 | 9.1 | 1.4 | 3.1 | 1.4 | 15.7 |
| 9. | | 10 | 0.4 | 0.0 | 13.6 | 0.4 | 3.3 | 0.3 | 18.0 |
| 10. | | 20 | 0.3 | 0.1 | 4.7 | 0.7 | 0.9 | 0.4 | 7.1 |
| 11. | | 30 | 0.0 | 0.0 | 0.0 | 0.7 | 0.3 | 0.0 | 1.0 |
| 12. | | 40 | 0.1 | 0.0 | 0.3 | 0.0 | 0.4 | 0.1 | 1.0 |
| 13. | | 50 | 0.0 | 0.1 | 0.1 | 0.0 | 0.1 | 0.0 | 0.4 |
| 14. | Control | 0 | 0.3 | 0.6 | 8.7 | 0.7 | 3.1 | 1.4 | 14.9 |

| | | | | | | | |
|---|---|---|---|---|---|---|---|
| LSD (P = 0.05) = | 0.52 | 0.35 | 3.50 | 1.00 | 1.30 | 0.93 | 4.10 |

TABLE 18
Second count of emerging weeds relative to Table 17 at ten (10)
days post-planting.

| | | mls 10% | | | | | | | |
|---|---|---|---|---|---|---|---|---|---|
| | | (w/w) solution | Yellow | | | | Morning- | Other | Total |
| | Treatment | per pot | Nutsedge | Crabgrass | Teaweed | Sicklepod | glory | Weeds | Weeds |
| 1. | Control | 0 | 3.4 | 0.6 | 8.4 | 1.6 | 3.0 | 1.3 | 18.3 |
| 2. | SOLYVER U | 5 | 3.6 | 0.4 | 8.6 | 1.1 | 4.1 | 1.1 | 19.0 |
| 3. | | 10 | 4.4 | 0.4 | 10.9 | 0.7 | 6.4 | 0.6 | 23.4 |
| 4. | | 20 | 5.9 | 0.1 | 8.0 | 1.1 | 1.4 | 0.1 | 16.7 |
| 5. | | 30 | 4.6 | 0.1 | 2.0 | 0.9 | 0.9 | 0.0 | 8.4 |
| 6. | | 40 | 3.4 | 0.0 | 0.1 | 0.1 | 0.7 | 0.0 | 4.4 |
| 7. | | 50 | 3.0 | 0.0 | 0.0 | 0.4 | 0.0 | 0.0 | 3.4 |
| 8. | SOLYVER MU | 5 | 2.9 | 0.7 | 7.9 | 1.4 | 3.3 | 0.9 | 17.0 |
| 9. | | 10 | 2.6 | 0.1 | 12.0 | 0.7 | 3.0 | 0.3 | 18.7 |
| 10. | | 20 | 3.4 | 0.3 | 4.3 | 1.0 | 0.9 | 0.9 | 10.7 |
| 11. | | 30 | 3.1 | 0.1 | 0.1 | 0.7 | 0.7 | 0.0 | 4.9 |
| 12. | | 40 | 1.7 | 0.0 | 0.3 | 0.0 | 0.3 | 0.3 | 2.6 |
| 13. | | 50 | 2.3 | 0.1 | 0.1 | 0.1 | 0.1 | 0.0 | 2.9 |
| 14. | Control | 0 | 2.3 | 0.3 | 7.3 | 0.9 | 2.9 | 1.3 | 14.9 |

| | | | | | | | |
|---|---|---|---|---|---|---|---|
| LSD (P = 0.05) = | 2.16 | 0.54 | 3.30 | 0.97 | 1.19 | 1.00 | 3.87 |

TABLE 19
Third count of emerging weeds relative to Table 17 and Table 18
seventeen (17) days post-planting.

| | | mls 10% | | | | | | | |
|---|---|---|---|---|---|---|---|---|---|
| | | (w/w) solution | Yellow | | | | Morning- | Other | Total |
| | Treatment | per pot | Nutsedge | Crabgrass | Teaweed | Sicklepod | glory | Weeds | Weeds |
| 1. | Control | 0 | 6.6 | 0.6 | 9.6 | 1.1 | 3.4 | 1.3 | 22.6 |
| 2. | | 5 | 6.1 | 0.6 | 8.1 | 1.4 | 4.6 | 0.7 | 21.6 |
| 3. | | 10 | 7.6 | 0.4 | 11.9 | 0.9 | 6.6 | 0.6 | 27.4 |
| 4. | | 20 | 8.3 | 0.1 | 8.1 | 1.1 | 1.7 | 0.4 | 19.9 |
| 5. | | 30 | 7.4 | 0.1 | 8.6 | 0.9 | 0.9 | 0.4 | 13.3 |
| 6. | | 40 | 7.4 | 0.1 | 0.3 | 0.6 | 0.7 | 0.1 | 9.8 |
| 7. | | 50 | 7.4 | 0.0 | 0.4 | 0.6 | 0.0 | 0.1 | 8.6 |
| 8. | SOLYVER MU | 5 | 6.7 | 0.9 | 7.9 | 1.4 | 3.6 | 0.6 | 21.0 |
| 9. | | 10 | 7.0 | 0.1 | 12.1 | 0.3 | 3.1 | 0.0 | 23.0 |
| 10. | | 20 | 6.1 | 0.4 | 5.6 | 1.0 | 1.1 | 0.1 | 14.4 |
| 11. | | 30 | 8.3 | 0.3 | 1.1 | 0.6 | 0.6 | 0.4 | 11.1 |
| 12. | | 40 | 8.1 | 0.0 | 0.6 | 0.3 | 0.3 | 0.4 | 9.7 |
| 13. | | 50 | 7.7 | 0.1 | 0.3 | 0.1 | 0.1 | 0.0 | 8.4 |
| 14. | Control | 0 | 5.6 | 0.4 | 6.7 | 1.0 | 3.1 | 0.7 | 17.6 |

| | | | | | | | |
|---|---|---|---|---|---|---|---|
| LSD (P = 0.05) = | 2.54 | 0.59 | 3.04 | 0.99 | 1.39 | 0.71 | 3.92 |

TABLE 20
First count of emerging weeds at six (6) days post-planting.

| | | mls 10% | | | | | | | |
|---|---|---|---|---|---|---|---|---|---|
| | | (w/w) solution | Yellow | | | | Morning- | Other | Total |
| | Treatment | per pot | Nutsedge | Crabgrass | Teaweed | Sicklepod | glory | Weeds | Weeds |
| 1. | Control | 0 | 0.0 | 1.0 | 6.3 | 0.6 | 3.1 | 0.3 | 11.3 |
| 2. | SOLYVER ATS | 5 | 0.1 | 0.3 | 7.3 | 0.7 | 2.6 | 0.1 | 11.1 |
| 3. | | 10 | 0.1 | 0.4 | 2.7 | 0.4 | 2.1 | 0.0 | 5.9 |
| 4. | | 20 | 0.0 | 0.0 | 0.6 | 0.6 | 0.3 | 0.0 | 1.4 |
| 5. | | 30 | 0.0 | 0.0 | 0.0 | 0.0 | 0.0 | 0.0 | 0.0 |
| 6. | | 40 | 0.1 | 0.0 | 0.1 | 0.1 | 0.1 | 0.0 | 0.6 |
| 7. | | 50 | 0.0 | 0.0 | 0.0 | 0.1 | 0.0 | 0.0 | 0.1 |
| 8. | SOLYVER MATS | 5 | 0.0 | 1.1 | 6.1 | 0.7 | 2.0 | 0.1 | 10.1 |
| 9. | | 10 | 0.0 | 0.9 | 5.4 | 0.7 | 1.7 | 0.0 | 8.7 |
| 10. | | 20 | 0.0 | 0.0 | 1.9 | 0.1 | 0.3 | 0.0 | 2.3 |
| 11. | | 30 | 0.0 | 0.0 | 0.0 | 0.0 | 0.0 | 0.0 | 0.0 |
| 12. | | 40 | 0.0 | 0.0 | 0.0 | 0.0 | 0.0 | 0.0 | 0.0 |
| 13. | | 50 | 0.0 | 0.0 | 0.0 | 0.0 | 0.0 | 0.0 | 0.0 |
| 14. | Control | 0 | 0.0 | 0.3 | 5.7 | 0.4 | 1.9 | 0.1 | 8.4 |

| | | | | | | | |
|---|---|---|---|---|---|---|---|
| LSD (P = 0.05) = | 0.19 | 0.84 | 2.24 | 0.69 | 1.06 | 0.23 | 2.45 |

TABLE 21
Second count of emerging weeds relative to Table 20 at thirteen
(13) days post-planting.

| | | mls 10% | | | | | | | |
|---|---|---|---|---|---|---|---|---|---|
| | | (w/w) solution | Yellow | | | | Morning- | Other | Total |
| | Treatment | per pot | Nutsedge | Crabgrass | Teaweed | Sicklepod | glory | Weeds | Weeds |
| 1. | Control | 0 | 2.9 | 1.0 | 6.3 | 0.9 | 2.7 | 0.6 | 14.4 |
| 2. | SOLYVER ATS | 5 | 6.0 | 0.7 | 8.4 | 1.6 | 2.4 | 0.7 | 15.3 |
| 3. | | 10 | 4.6 | 1.1 | 1.1 | 0.6 | 1.9 | 0.3 | 9.6 |
| 4. | | 20 | 4.0 | 0.8 | 0.0 | 0.8 | 0.0 | 0.1 | 4.7 |
| 5. | | 30 | 3.6 | 0.4 | 0.1 | 0.0 | 0.0 | 0.0 | 4.1 |
| 6. | | 40 | 3.9 | 0.4 | 0.1 | 0.1 | 0.0 | 0.4 | 5.0 |
| 7. | | 50 | 2.7 | 0.0 | 0.1 | 0.1 | 0.0 | 0.0 | 3.0 |
| 8. | SOLYVER MATS | 5 | 4.6 | 2.7 | 2.0 | 0.6 | 2.1 | 1.3 | 13.8 |
| 9. | | 10 | 4.0 | 1.0 | 1.0 | 0.7 | 1.8 | 0.1 | 8.1 |
| 10. | | 20 | 3.7 | 0.7 | 0.4 | 0.1 | 0.8 | 0.4 | 5.7 |
| 11. | | 30 | 4.1 | 0.8 | 0.3 | 0.1 | 0.0 | 0.1 | 5.0 |
| 12. | | 40 | 3.1 | 0.0 | 0.7 | 0.0 | 0.0 | 0.0 | 3.9 |
| 13. | | 50 | 2.7 | 0.0 | 1.0 | 0.0 | 0.0 | 0.0 | 3.7 |
| 14. | Control | 0 | 3.7 | 0.6 | 5.7 | 0.6 | 1.7 | 0.3 | 12.6 |

| | | | | | | | |
|---|---|---|---|---|---|---|---|
| LSD (P = 0.05) = | 2.14 | 1.30 | 1.60 | 0.77 | 1.07 | 0.76 | 8.11 |

TABLE 22
Third count of emerging weeds relative to Table 20 and Table 21
at twenty-one (21) days post-planting.

| | | mls 10% | | | | | | | |
|---|---|---|---|---|---|---|---|---|---|
| | | (w/w) solution | Yellow | | | | Morning- | Other | Total |
| | Treatment | per pot | Nutsedge | Crabgrass | Teaweed | Sicklepod | glory | Weeds | Weeds |
| 1. | Control | 0 | 5.9 | 1.8 | 6.4 | 0.7 | 2.9 | 0.6 | 17.7 |
| 2. | SOLYVER ATS | 5 | 7.3 | 1.6 | 8.8 | 1.4 | 2.4 | 0.6 | 16.6 |
| 3. | | 10 | 6.7 | 1.0 | 1.0 | 0.6 | 1.3 | 0.6 | 10.1 |
| 4. | | 20 | 5.0 | 0.0 | 0.8 | 0.3 | 0.0 | 0.0 | 5.6 |
| 5. | | 30 | 6.7 | 0.4 | 0.4 | 0.0 | 0.0 | 0.1 | 6.7 |
| 6. | | 40 | 4.9 | 0.7 | 0.1 | 0.0 | 0.1 | 0.7 | 6.6 |
| 7. | | 50 | 4.1 | 0.3 | 0.8 | 0.1 | 0.0 | 0.0 | 4.7 |
| 8. | SOLYVER MATS | 5 | 6.4 | 3.3 | 2.4 | 0.7 | 1.9 | 1.8 | 15.0 |
| 9. | | 10 | 4.9 | 1.1 | 0.9 | 0.9 | 0.9 | 0.6 | 9.1 |
| 10. | | 20 | 6.7 | 0.7 | 0.3 | 0.1 | 0.1 | 0.8 | 8.3 |
| 11. | | 30 | 5.7 | 0.1 | 0.8 | 0.1 | 0.0 | 0.4 | 6.7 |
| 12. | | 40 | 4.4 | 0.0 | 0.7 | 0.0 | 0.0 | 0.0 | 5.1 |
| 13. | | 50 | 4.1 | 0.0 | 1.1 | 0.0 | 0.0 | 0.0 | 5.3 |
| 14. | Control | 0 | 5.7 | 0.6 | 4.7 | 0.6 | 1.9 | 0.0 | 18.4 |

| | | | | | | | |
|---|---|---|---|---|---|---|---|
| LSD (P = 0.05) = | 2.21 | 1.46 | 1.52 | 0.84 | 1.05 | 0.68 | 3.28 |

TABLE 23
First count of emerging weeds at six (6) days post-planting.

| | | mls 10% | | | | | | | |
|---|---|---|---|---|---|---|---|---|---|
| | | solution/ | Yellow | | | | Morning- | Other | Total |
| | Treatment | kg soil | Nutsedge | Crabgrass | Teaweed | Sicklepod | glory | Weeds | Weeds |
| 1. | Control | 0 | 1.0 | 0.4 | 18.7 | 3.0 | 6.6 | 2.7 | 27.6 |
| 2. | Solyver MU | 5 | 0.6 | 1.4 | 13.9 | 3.0 | 5.0 | 1.9 | 25.7 |
| 3. | | 10 | 1.7 | 0.4 | 9.1 | 3.4 | 6.0 | 0.9 | 21.6 |
| 4. | | 20 | 1.9 | 0.0 | 8.3 | 2.4 | 8.3 | 0.1 | 11.0 |
| 5. | | 30 | 1.9 | 0.0 | 1.8 | 1.0 | 1.0 | 0.1 | 5.3 |
| 6. | | 40 | 1.0 | 0.0 | 0.1 | 0.3 | 1.0 | 0.1 | 2.6 |
| 7. | | 50 | 0.0 | 0.0 | 0.0 | 0.1 | 0.3 | 0.0 | 0.4 |
| 8. | Solyver MCD | 5 | 2.0 | 0.4 | 10.0 | 2.9 | 5.7 | 0.6 | 21.6 |
| 9. | | 10 | 2.0 | 0.1 | 1.7 | 1.3 | 2.9 | 0.1 | 8.1 |
| 10. | | 20 | 0.4 | 0.0 | 0.3 | 0.7 | 1.1 | 0.0 | 2.6 |
| 11. | | 30 | 0.1 | 0.1 | 0.6 | 0.4 | 0.4 | 0.0 | 1.7 |
| 12. | | 40 | 0.0 | 0.0 | 0.0 | 0.0 | 0.4 | 0.0 | 0.4 |
| 13. | | 50 | 0.8 | 0.0 | 0.0 | 0.0 | 0.1 | 0.0 | 0.4 |
| 14. | Control | 0 | 2.3 | 0.4 | 11.6 | 4.0 | 6.0 | 1.7 | 26.0 |

| | | | | | | | |
|---|---|---|---|---|---|---|---|
| LSD (P = 0.05) = | 1.17 | 0.68 | 2.89 | 1.22 | 1.54 | 0.84 | 3.44 |

TABLE 24
Second count of emerging weeds relative to Table 23 at fourteen
(14) days post-planting.

| | | mls 10% | | | | | | | |
|---|---|---|---|---|---|---|---|---|---|
| | | solution/ | Yellow | | | | Morning- | Other | Total |
| | Treatment | kg soil | Nutsedge | Crabgrass | Teaweed | Sicklepod | glory | Weeds | Weeds |
| 1. | Control | 0 | 7.0 | 1.0 | 12.1 | 3.4 | 6.1 | 1.7 | 31.4 |
| 2. | Solyver MU | 5 | 5.0 | 2.0 | 12.1 | 8.7 | 6.0 | 2.0 | 30.1 |
| 3. | | 10 | 6.8 | 0.8 | 8.0 | 0.0 | 5.7 | 1.9 | 27.1 |
| 4. | | 20 | 7.9 | 0.3 | 3.0 | 3.3 | 3.2 | 1.6 | 19.3 |
| 5. | | 30 | 7.7 | 0.9 | 1.6 | 1.0 | 0.6 | 1.6 | 13.0 |
| 6. | | 40 | 0.0 | 0.4 | 0.0 | 0.7 | 0.4 | 2.4 | 9.0 |
| 7. | | 50 | 4.9 | 0.3 | 0.8 | 0.1 | 0.0 | 1.4 | 7.0 |
| 8. | Solyver MCD | 5 | 6.0 | 0.0 | 10.6 | 3.0 | 6.3 | 2.0 | 28.7 |
| 9. | | 10 | 6.4 | 0.6 | 2.1 | 1.4 | 3.6 | 1.0 | 10.1 |
| 10. | | 20 | 6.8 | 0.0 | 1.1 | 1.6 | 2.1 | 1.0 | 11.1 |
| 11. | | 30 | 0.3 | 0.4 | 1.0 | 0.6 | 0.9 | 0.1 | 9.0 |
| 12. | | 40 | 3.6 | 0.1 | 0.4 | 0.7 | 0.4 | 0.6 | 6.7 |
| 13. | | 50 | 3.9 | 0.0 | 0.1 | 0.1 | 0.1 | 0.3 | 4.6 |
| 14. | Control | 0 | 0.6 | 0.4 | 11.1 | 8.9 | 4.6 | 1.0 | 28.6 |

| | | | | | | | |
|---|---|---|---|---|---|---|---|
| LSD (P = 0.05) = | 2.07 | 0.87 | 2.50 | 1.24 | 1.57 | 2.00 | 4.67 |

TABLE 25
Third count of emerging weeds relative to the Table 23 and
Table 24 at twenty-three (23) days post-planting.

| | | mls 10% | | | | | | | |
|---|---|---|---|---|---|---|---|---|---|
| | | solution/ | Yellow | | | | Morning- | Other | Total |
| | Treatment | kg soil | Nutsedge | Crabgrass | Teaweed | Sicklepod | glory | Weeds | Weeds |
| 1. | Control | 0 | 7.6 | 1.3 | 11.6 | 3.7 | 5.9 | 1.8 | 31.6 |
| 2. | Solyver MU | 5 | 5.1 | 1.7 | 9.7 | 3.7 | 0.8 | 2.0 | 27.6 |
| 3. | | 10 | 7.0 | 1.4 | 6.6 | 3.4 | 5.9 | 1.7 | 26.0 |
| 4. | | 20 | 8.4 | 0.9 | 3.3 | 3.7 | 3.7 | 1.0 | 20.6 |
| 5. | | 30 | 11.4 | 1.0 | 1.3 | 1.7 | 0.6 | 0.6 | 16.6 |
| 6. | | 40 | 11.3 | 0.6 | 0.7 | 0.7 | 0.3 | 2.3 | 15.9 |
| 7. | | 50 | 8.4 | 0.1 | 0.7 | 0.0 | 0.0 | 1.4 | 11.0 |
| 8. | Solyver MCD | 5 | 6.6 | 1.1 | 8.3 | 3.0 | 6.0 | 1.7 | 26.7 |
| 9. | | 10 | 7.3 | 0.7 | 1.9 | 1.9 | 3.4 | 0.6 | 15.7 |
| 10. | | 20 | 6.1 | 0.1 | 1.0 | 2.0 | 2.3 | 1.3 | 13.1 |
| 11. | | 30 | 8.4 | 0.6 | 1.3 | 0.9 | 0.9 | 0.4 | 12.7 |
| 12. | | 40 | 5.4 | 0.6 | 0.6 | 0.7 | 0.8 | 0.0 | 8.7 |
| 13. | | 50 | 7.6 | 0.1 | 0.1 | 0.0 | 0.1 | 0.6 | 8.9 |
| 14. | Control | 0 | 6.1 | 0.9 | 10.7 | 3.4 | 4.3 | 0.9 | 28.8 |

| | | | | | | | |
|---|---|---|---|---|---|---|---|
| LSD (P = 0.05) = | 2.80 | 0.85 | 1.98 | 1.21 | 1.64 | 1.48 | 4.31 |

In the foregoing description, it will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

All publications and patent applications cited in this specification are herein incorporated by reference as if each individual publication or patent application were specifically and individually indicated to be incorporated by reference. If the meaning of a term utilized in this application is unclear in view of a contrary meaning provided in any cited publication or patent application, the meaning provided in the specification of the application shall be used.

We claim:

1. A composition comprising:
(a) molasses;
(b) one or more acids; and
(c) one or more nitrogen sources.

2. The composition of claim 1, wherein the composition has a molar ratio of total carbon to total nitrogen (C:N) of about (22.4-5.6): 1.

3. The composition of claim 1, further comprising a phosphorus source, a potassium source, or both.

4. The composition of claim 1, wherein the acid is an organic acid.

5. The composition of claim 4, wherein the organic acid comprises a carboxylic acid, a polycarboxyclic acid, or a polyhydroxycarboxylic acid.

6. The composition of claim 5, wherein the carboxylic acid is selected from a group consisting of acetic acid, propionic acid, butyric acid, valeric acid and mixtures thereof.

7. The composition of claim 1, wherein the acid is a weak acid.

8. The composition of claim 1, wherein the acid is an inorganic acid.

9. The composition of claim 8, wherein the inorganic acid is selected from a group consisting of phosphoric acid, sulfuric acid, and mixtures thereof.

10. The composition of claim 1, wherein the acid comprises a mixture of one or more organic acids and one or more inorganic acids.

11. The composition of claim 10, wherein the organic acid comprises a carboxylic acid and the inorganic acid comprises phosphoric acid.

12. The composition of claim 3, wherein the potassium source is KOH.

13. The composition of claim 1, wherein the nitrogen source comprises urea.

14. The composition of claim 1, comprising:
(a) molasses;
(b) propionic acid;
(c) phosphoric acid;
(d) KOH;
(e) urea; and
(f) water,
wherein the composition has a molar ratio of total carbon to total nitrogen (C:N) of about (22.4-5.6):1.

15. The composition of claim 1, further comprising glycerin.

16. The composition of claim 1, wherein the composition comprises ammonium thiosulfate.

17. The composition of claim 1, further comprising guanidine-HCl.

18. The composition of claim 1, further comprising a sulfur source.

19. A method for controlling soil born pests and weeds and enhancing growth of plants, the method comprising applying the composition of claim 1 to soil at an application rate that delivers 0.5-5.0 g/kg soil of molasses.

20. A method for preparing a composition, the method comprising combining:
(a) molasses;
(b) one or more acids; and
(c) one or more nitrogen sources to prepare the composition,
wherein the composition has a molar ratio of total carbon to total nitrogen (C:N) of about (22.4-5.6):1.
